(19) United States
(12) Patent Application Publication
(10) Pub. No.: US 2010/0083528 A1
(43) Pub. Date: Apr. 8, 2010

(54) METHOD OF DRYING CLOTHING WITH AUTO SHUT OFF AND PRORATED BILLING

(75) Inventor: Dennis Slutsky, Providence, RI (US)

Correspondence Address: WOLF GREENFIELD & SACKS, P.C., 600 ATLANTIC AVENUE, BOSTON, MA, 02210-2206, US

(73) Assignee: American Dryer Corp., Fall River, MA (US)

(21) Appl. No.: 12/571,632

(22) Filed: Oct. 1, 2009

Related U.S. Application Data
(63) Continuation of application No. 11/838,378, filed on Aug. 14, 2007, now abandoned.
(60) Provisional application No. 60/822,432, filed on Aug. 15, 2006.

(51) Int. Cl. F26B 3/02

(52) U.S. Cl. 34/486

(57) ABSTRACT

The method of drying of the present invention includes providing a dryer with a payment receiving means providing a heat source in thermal communication with the dryer. Clothes are then inserted into the dryer and a means of payment to the payment receiving means of the dryer is provided. A drying cycle is then initiated to operate the dryer. Moisture is sensed in the clothes ax the dryer is being operated. The dryer is turned off when the moisture in the clothes exceeds a predetermined amount representing a dry load. Payment is received from the means of payment while the dryer is in operation. Payment is stopped from the means of payment when the dryer has ceased operation. As a result, the user has paid only for the time for the dryer to provide a dry load of laundry.

### RELATED APPLICATIONS

This application is a continuation of U.S. application Ser. No. 11,838,378, entitled “Method of Drying Clothing With Auto Shut Off and Prorated Billing,” filed on Aug. 14, 2007, which claims priority to U.S. Provisional Application Ser. No. 60/822,432, filed Aug. 15, 2006, incorporated by reference in their entirety.

### BACKGROUND OF INVENTION

The present invention generally relates to drying apparatus and methods of operating the same. More specifically, the present invention relates to dryers for drying clothes and methods of operating the same. The present invention further relates to coin-operated (pay for use) clothes dryers and making such apparatus more efficient in operation and easier to use.

In the prior art, clothes dryers are very well known in the art. In particular, coin-operated or pay for use clothes dryers are commonly used so that a person can use the dryer as needed to obviate the need to own one.

Coin-operated clothes dryers are typically located in a “Laundromat” or other similar locations. A typical coin-operated dryer is shown in FIG. 1. For use by many customers at the same time, these locations typically house several coin-operated dryer machines, which are typically powered by gas. Other fuels may be used. Other heat sources can be also be used. There is a concern associated with operating a laundry facility as to the continuing cost of operation of the equipment, including dryers. There is a desire to operate coin-operated dryer machines in a more cost-effective manner by reducing energy consumption. There is a specific need to avoid superfluous drying of clothes to save energy. There is a desire to use only the amount of energy that is needed to provide a full drying of a load of laundry.

In the prior art, as in FIG. 1, it is well known that a typical coin-operated dryer is operated by paying for a block of drying time. For example, a quarter is inserted into the dryer for 15 minutes of drying time. At the end of the time period, the dryer shuts down and the clothes are removed by the user. At the end of the time period, the drying condition of the clothes is either 1) just right; 2) too wet; or 3) over-dried. If the clothes are dried just right at the end of the period, the dryer has operated in an efficient manner in that just enough energy was used to dry the clothes properly.

However, in practice, this is not usually the case. It is common that the clothes are still too wet after the purchased time period has expired. At that point, the user buys an additional block of drying time, which is commonly 15 minutes. It is very common that the clothes are dried to just the right degree with additional time remaining on the purchased amount. This additional time is not needed for drying the clothes which expends extra energy and cost for the drying operation. Moreover, the over-drying of clothes not only unnecessarily adds cost to operation of the dryer for unneeded dry time but can damage the clothes.

This problem is exacerbated in the common situation of where a user buys much more time than is needed to ensure that when they return to the coin-operated laundry facility, their clothes will not be wet and in need of further drying. In this scenario, over-dried clothes are an accepted drawback that is outweighed by not having to buy additional dry time requiring further wait time for the user. Also, users commonly over-dry their clothes to use up all of the dry time that they have purchased to get “their money's worth”.

As illustrated above, over-drying of clothes is extremely common in a coin-operated laundry where excess energy is used thereby raising the overall cost of operation of the laundry. Thus, there is a desire to avoid over-drying of clothes. There is a further need to reduce the energy cost associated with operating a laundry facility while still providing the consumer with a properly dried load of laundry. There is a desire to deliver the same ability to dry clothes to a proper dried condition to the consumer while consuming less energy. There is a need to only charge a user only for what is needed to dry a given load of laundry.

### SUMMARY OF INVENTION

The present invention solves the problems associated with prior art clothes dryers and coin-operated laundry facilities. It reduces the overall energy cost of operating the facility while providing the same end result, namely, providing full dried laundry to the user.

The present invention is a new and novel method of drying clothing. The method of drying clothing includes providing a dryer, preferably a coin-operated clothes dryer. The method of drying of the present invention further includes providing a dryer with a payment receiving means providing a heat source in thermal communication with the dryer. Clothes are then inserted into the dryer and a means of payment to the payment receiving means of the dryer is provided. A drying cycle is then initiated to operate the dryer. Moisture is sensed in the clothes as the dryer is being operated. The dryer is turned off when the moisture in the clothes exceeds a predetermined amount representing a dry load. Payment is received from the means of payment while the dryer is in operation. Payment is stopped from the means of payment when the dryer has ceased operation. As a result, the user has paid only for the time for the dryer to provide a dry load of laundry.

It is therefore an object of the embodiment to provide a method of drying clothing that charges the user only for what is needed to dry a given load of laundry.

There is a further need to dry clothes to a proper dried condition to the consumer while consuming less energy.

It is a further object of the embodiment to provide a method of drying clothing that provides a coin-operated clothes which generates more revenues for the laundry operator.

Another object of the embodiment is to provide a method of drying clothing that provides better drying for clothes.

### BRIEF DESCRIPTION OF DRAWINGS

The novel features which are characteristic of the method of drying clothing are set forth in the appended claims. However, the method of drying clothing, together with further embodiments and attendant advantages, will be best understood by reference to the following detailed description taken in connection with the accompanying drawings in which:

FIG. 1 is a perspective view of a coin-operated dryer as used in the prior art;

FIG. 2 is a schematic drawing showing operation of the dryer in accordance with the method of the present invention; and

FIG. 3 is a flow chart illustrating the method of the present invention for drying clothing with automatic shut off and prorated billing.

### DETAILED DESCRIPTION

The present invention solves the problems associated with prior art methods of drying clothes and, in particular, drying clothes using a dryer. The present invention solves the problems associated with prior art clothes dryers and coin-operated laundry facilities. A new and novel method for drying clothing enables a user to be billed only for the time that is need to dry the load of laundry. Thus, the user is paying for a dry load of laundry and the time to dry that load not for large blocks of time without regard to whether the load is dry or not.

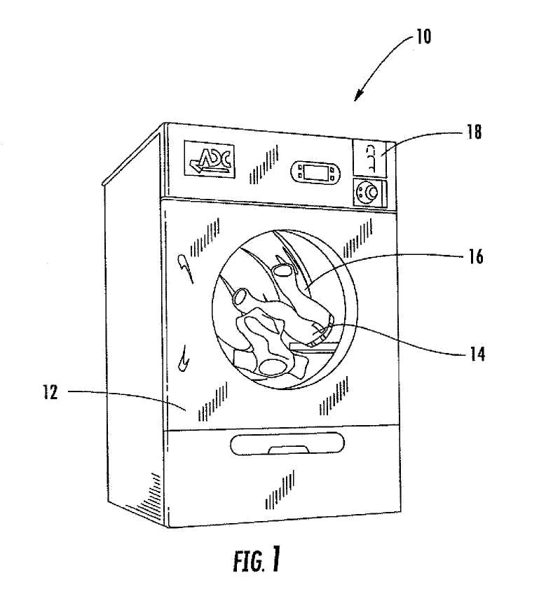

In accordance with the method for drying clothes, a coin-operating clothes dryer 10 of the type shown in FIG. 1 is provided. The dryer in FIG. 1 is merely an example and any other coin-operated clothes dryer 10 may be used that is capable of drying clothes for a predetermined period of time. The dryer 10 includes a door 12 into which clothes 14 can be loaded into a basket 16. Drying time is purchased by inserting coins or debit card (not shown), for example, into a payment interface 18, such as coin counting device. The operating of such a coin-operated dryer is so well known in the art that further discussion is not needed herein.

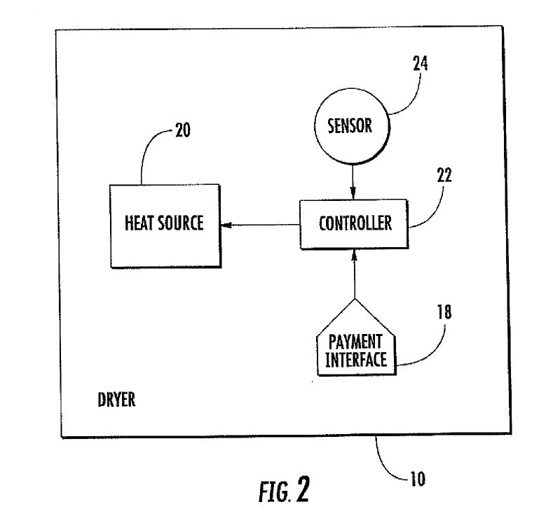

The method of drying of the present invention employs a typical coin-operated dryer 10 of the type shown in FIG. 1. However, as will be discussed in detail below, this dryer 10 is operated in a fashion completely different than in the prior art. In FIG. 1, receipt of payment at the payment interface triggers a timer to cause the dryer 10 to operate for a predetermined period of time. These coin-operated timer mechanisms and configurations are well known in the art and need not be discussed in detail herein. Referring to both FIGS. 1 and 2, the dryer of the present invention is preferably modified to include a payment interface 18, which, for example, includes a media reader that can be of any configuration, such as a magnetic card or RFID (radio frequency identification) tag reader.

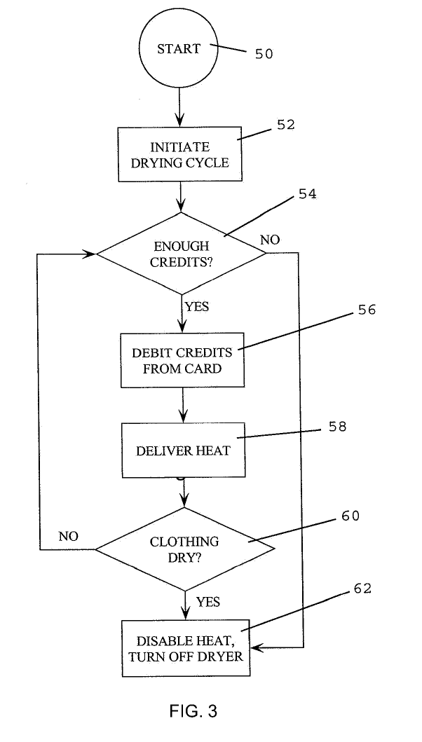

Still referring to FIG. 2, the payment interface 18 is in electrical communication with a controller 22 to provide information as to the status of the amount of payment or credits available to the user. The moisture sensor 24 is also provided, the output of which is in electrical communication with the controller 22 to provide information relating to the moisture or wetness of the clothes being dried. The present invention is unique in that additional functionality of controller 22 is provided to stop the heat source when desired, namely when the clothes reach a predetermined amount of dryness indicative of a dry load. This functionality is employed to control the heat delivery, as will be described in detail below in connection with FIG. 3.

More specifically, sensor 24 that can detect when a load of clothes are fully dry. This monitors the amount of moisture in the clothes. Many different types of sensors 24 and tracking software can be used. For example, a sensor 24 is used in conjunction with a monitoring algorithm to track “wet hits”. A given threshold can be set to determine when a load is considered “dry” to stop the heat source 20. It is also possible that the user can set how dry or wet they would like their clothes before a drying cycle and heat source 20 is stopped. It is also possible for the threshold be set according to the recommendations of a given clothing manufacturer.

It is envisioned that the user of the pay-dryer the uses the method of the present invention purchases a number of credits which correspond to dry time on the dryer. For example, a 1:1 ratio can be used where a penny ($0.01) corresponds to one minute of drying time. As a result, in this example, 100 minutes of drying time can be purchased for $1.00. In use, a media writer/reader is provided at the laundry site, either as a separate unit or incorporated directly into the dryer, that also accepts coins, dollar bills and/or bank credit and debit cards. The user purchases a desired number of credits that corresponds to a dollar value. Those credits are placed on the media, such as magnetically on a card or electronically on a RFID tag, using methods known in the art. For example, the user inserts payment into a vending machine (not shown) which dispenses a re-chargeable magnetic reader card that has preloaded on it a given amount of credits that correspond to an amount of drying time. This card can be re-inserted into the vending machine so that additional credits can be purchased.

Referring now to FIG. 3, a flow chart the sets forth the method of the present invention is shown in detail. The method is first started at 50. Next, the drying cycle is first initiated at 52 by the user presenting some type of payment. The card, by way of example, has a number of credits thereon, is inserted into the payment interface 18, such as a magnetic reader in the dryer 10 used for carrying out the method of the present invention. Clothes are loaded into the dryer 10 and the heat source 20 is turned on the drying of the clothing begins at 58 if there are enough credits at 54. The time of the drying cycle is not determined based on the amount of payment as in the prior art but on whether the clothes in the dryer are, in fact, dry. The dryer 10 determines whether there are enough credits to operate the dryer at 54 and then debits them at 56. If so, the dryer 10 begins to operate with heat is delivered from the heat source 20 to the clothes 14 with tumbling while credits (corresponding to time) are simultaneously debited at 56 by the payment interface 18, such as from a magnetic card. If there are no credits remaining on the card, the user is instructed to purchase additional credits for drying time.

Most importantly, in accordance with the present invention, the dryer will continue to dry the clothes at 58 and debit credits 56 until it is sensed by sensor 24 that they are fully dry. Thus, the dryer 10 will continue to incrementally debit the magnetic card via the payment interface 18 of credits as it dries the clothes. Debiting of the card will continue until the clothes are dry at 60 at which time, the dryer is turned off at 62. As a result, the user is charged for providing a dried load of clothes not by time or blocks of time. They are billed exactly for what was needed to dry the clothes, not too much or too little.

If there are not enough funds, such as the debit card runs out of credits during a drying cycle and before the load is fully dry, it is preferred that the dryer 10 stops operation where the user is instructed to purchase more credits for additional time to resume operation. It is also possible that the additional time to be purchased can be automatically charged to a person's credit card, for example. It that connection, it is also possible, in similar fashion to a gasoline pump, that a user use a bank credit card or bank debit card directly at the dryer 10 where only the amount of time used for a dry is charged to the bank card.

In view of the foregoing, a new and novel dryer and method of operating a dryer 10 is provided that provides a dry load of clothes 14 to the user. The user is billed, such as by debiting credits from media or charging to media, only for the time that is used to dry the load 14. There is no need to step the heat down during the drying process to avoid excess use of energy. Over-drying is also avoided because drying stops when the load of laundry 14 is fully dried. Only the amount of time used is automatically charged to the user.

It would be appreciated by those skilled in the art that various changes and modifications can be made to the illustrated embodiments without departing from the spirit of the present invention. All such modifications and changes are intended to be covered by the present invention and appended claims.

1. A method of drying clothing, comprising the steps of:
providing a dryer with a payment receiving means;
providing a heat source in thermal communication with the dryer;
inserting clothes into the dryer;
introducing a debit media device to the payment receiving means of the dryer;
initiating a drying cycle;
operating the dryer;
sensing moisture in the clothes;
turning off the dryer when the moisture in the clothes have exceeded a predetermined amount recommended by a clothes manufacturer representing a dry load;
receiving payment automatically from the debit media device while the dryer is in operation;
stopping payment from the debit media device when the dryer has ceased operating due to the dry load; and
turning off the dryer when the means of payment is extinguished.

2. The method of claim 1, wherein the debit media device is in the configuration selected from the group consisting of a magnetic card and a RFID tag.

3. The method of claim 1, wherein the means of payment is a bank card.

4. The method of claim 1, wherein the means of payment is a credit card.
